(19) United States
(12) Patent Application Publication
(10) Pub. No.: US 2013/0100150 A1
(43) Pub. Date: Apr. 25, 2013

(54) Apparatus, Display Module and Method for Adaptive Blank Frame Insertion

(71) Applicant: Jarmo Juhani Kurikko, Espoo (FI)

(72) Inventor: Jarmo Juhani Kurikko, Espoo (FI)

(73) Assignee: NOKIA CORPORATION, Espoo (FI)

(21) Appl. No.: 13/636,781

(22) PCT Filed: Mar. 25, 2010
(86) PCT No.: PCT/IB10/51320

§ 371 Date: Jan. 9, 2013

(51) Int. Cl. G09G 5/00

(52) U.S. Cl. CPC G09G 5/001
USPC 345/545

(57) ABSTRACT

An apparatus including a controller; a display; a frame memory configured to load a frame of data to the display and configured to be filled by a frame of data from the controller, wherein the controller is configured to control the insertion of blank fields between frames of data displayed on the display in dependence upon a detected context.

### FIELD OF THE INVENTION

Embodiments of the present invention relate to an apparatus, a display module, or a method, for example.

### BACKGROUND TO THE INVENTION

High contrast high resolution displays are now available for hand-portable electronic devices. These displays can display stationary images exceptionally well. However, if the images move they may appear blurred to a human user.

### BRIEF DESCRIPTION OF VARIOUS EMBODIMENTS OF THE INVENTION

According to various, but not necessarily all, embodiments of the invention there is provided an apparatus comprising: a controller; a display; a frame memory configured to load a frame of data to the display and configured to be filled by a frame of data from the controller, wherein the controller is configured to control the insertion of blank fields with respect to frames of data displayed on the display in dependence upon a detected context.

According to various, but not necessarily all, embodiments of the invention there is provided a module comprising: a controller; a display; a detector; a frame memory configured to load a frame of data to the display and configured to be filled by a frame of data from the controller, wherein the controller is configured to control the insertion of blank fields with respect to frames of data displayed on the display in dependence upon a context detected by the detector.

According to various, but not necessarily all, embodiments of the invention there is provided a method comprising: displaying a frame of data in a display; displaying a blank field on the display for a duration dependent upon a detected context; and displaying a next frame of data in the display.

Mobile apparatus in particular are used in different often rapidly changing contexts. For example, a user may walk from outside on a sunny day to a shady room inside. A display that has sufficient luminance for outside use in bright conditions will be too bright for shady conditions. Some but not necessarily all embodiments of the present invention solve this problem by inserting blank fields with respect to frames of data displayed on a display in dependence upon a detected context.

### BRIEF DESCRIPTION OF THE DRAWINGS

For a better understanding of various examples of embodiments of the present invention reference will now be made by way of example only to the accompanying drawings in which:

FIG. 1 schematically illustrates an apparatus including a display;

FIG. 2 schematically illustrates a timing diagram for the apparatus of FIG. 1;

FIG. 3 schematically illustrates the apparatus with backlighting; and

FIG. 4 schematically illustrates a method of operation for a display.

### DETAILED DESCRIPTION OF VARIOUS EMBODIMENTS OF THE INVENTION

In the following description the transfer of data to a frame memory will be described and the transfer of data from a frame memory will be described. For clarity of description, the term ‘fill’ will be used to denote transfer of data to a frame memory and the term ‘load’ will be used to denote transfer of data from a frame memory. No other special technical meaning is intended merely by the use of different terms to denote the transfer of data.

The Figures schematically illustrates an apparatus 10 comprising: a controller 2; a display 6; a frame memory 4 configured to load a frame of data 5 to the display 6 and configured to be filled by a frame of data 3 from the controller 2, wherein the controller 2 is configured to control the insertion of blank fields 11 with respect to frames of data 5 displayed on the display 6 in dependence upon a detected context 15.

The apparatus 10, in the example illustrated, comprises a detector 14 for detecting the context 15. However, in other embodiments the apparatus 10 may not comprise a detector 14.

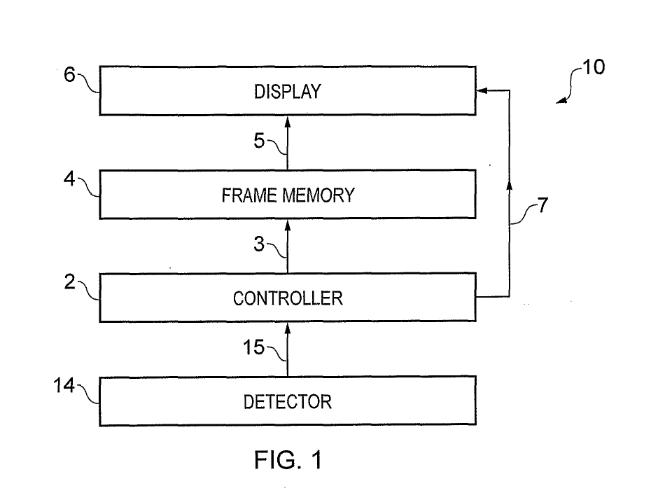

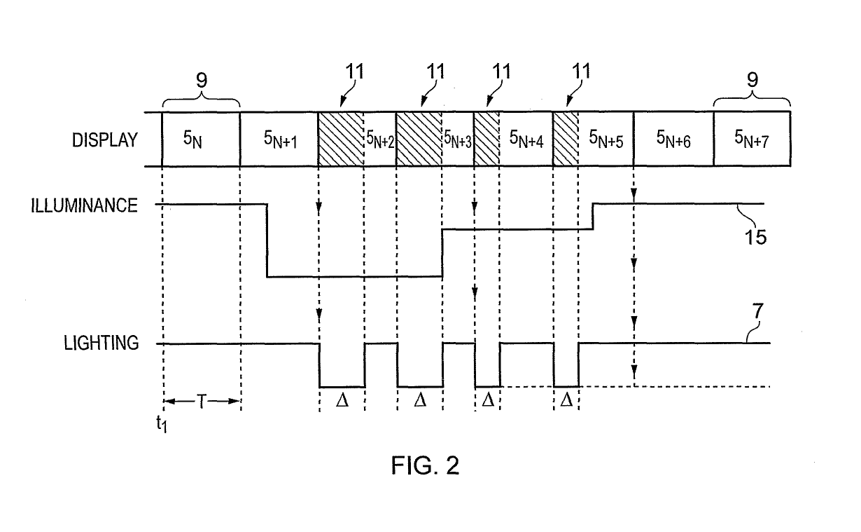

Referring to FIGS. 1 and 2, the controller 2 has an interface to the frame memory 4 over which successive frames of data 3 are sent to fill the frame memory 4. In the illustrated example, the frames of data 3 are sent periodically every time period T. The frames of data 3 may be sent asynchronously and without flow control.

The frame memory 4 has an interface to the display 6 over which the successive frames of data 5 stored in the frame memory 4 are loaded to the display 6 and are displayed as display frames 9 with a periodicity of T. The frame of data 5 loaded to the display 6 may be the same as the frame of data 3 previously sent by the controller 2 to fill the frame memory 4.

The frame memory 4 may operate as a first-in-first-out register. It may only have storage capacity for one frame of data. Alternatively it may have storage capacity for more than one frame of data.

The controller 2 is configured to insert blank fields (images) 11 within the display frames 9 using control signal 7.

The blank fields may in some embodiments be blank (sub) frames 11 within the display frame 9 and between (sub) frames of data 5. A display frame 9 of duration T can therefore be shared between a blank (sub) frame 11 of duration Δ and a (sub) frame of data 5 of duration T−Δ. The blank fields 11 in this example last Δ and start at time t1+mT where m is an integer and where Δ is a parameter controlled by the controller 2 in dependence upon a detected context 15. In this example, the display frame 9 is time divided between the wholly blank (sub) frame 11 and the data (sub) frame 5.

In other embodiments, the blank field 11 and the data frame 5 co-exist with the blank field overlying a portion of the display frame 9 with the other portion of the display frame 9 being occupied by data frame(s). The blank field 11 progressively scans across the display frame 9 as display refresh (scanning) proceeds. The blank field may be positioned at the interface between the tail end of a leading frame of data and a leading end of a following frame of data. As the following frame of data progresses across the display towards an edge of the display, the blank field 11 in advance of it reduces in size and another blank field following it increases in size.

A blank field 11 may be a field that contains no data so that the frame or frame portion appears black or contains adapted data such that the frame or frame portion appears a different monotone color or appears dimmed, for example.

The display 6 may, in some embodiments be a high output luminance display. The display 6 may be, for example, an active matrix (AM) organic light emitting diode (OLED) display or a thin film transistor (TFT) liquid crystal display (LCD). The display 6 may have high contrast and high resolution.

The display 6 may operate with a display frame rate of 60 Hz or 75 Hz, for example. This is three times the Phase Alternate Line (PAL) rate, 2.5 times the National Television System Committee (NTSC) rate and approximately three times a film frame rate.

The detected context 15 may, in one example embodiment be that the content represented by successive data frames 5 loaded into the display 6 comprises a fast moving image. The fast moving image may, for example, result from the display of video or as a consequence of a user scrolling or moving content on the display 6. In this embodiment, the detector 14 may detect the content type represented by the data frames 5. The detector 14 may be integrated as a part of the controller 2 or display 6. Variation in luminance arising from insertion of blank fields 11 may be compensated for by controlling the intensity of the pixels of the display 6 or by calculating a modified data frame 5 to be uploaded into the display 6.

The following description describes the use of blank (sub) frames 11, however, it should be appreciated that its teaching has a more general application relating to the insertion of blank fields 11 in general including the insertion of blank fields 11 that overlie a portion of the data frame 5 in the display frame 9.

The controller 2 is configured to start inserting blank fields 11 between frames of data 5 displayed on the display 6 in dependence upon detecting a predetermined change in context. The change in context may be the detection of a representation of a fast moving image in the frames of data 5 or the detection of a mode in which the likelihood of a representation of fast moving image in the frames of data 5 occurring is high.

The detected context 15 may, alternatively or additionally, be an external or environmental or ambient context that is dependent upon the surrounding, external environment to the apparatus 10 at that time. For example, the content 15 may be ambient light conditions such as ambient illuminance. In this example, the detector 14 may be an ambient light sensor that detects the intensity of light falling on the apparatus 10. In some implementations, the ambient light sensor 14 may be integrated as part of the display 6.

The controller 2 is configured to start inserting blank fields 11 between frames of data 5 displayed on the display 6 in dependence upon detecting a predetermined change in context 15 such as a decrease in the detected illuminance below a threshold. In this low illuminance context, the luminance of the display 6 may be too high and the insertion of blank fields 11 reduces the effective brightness to an acceptable level.

In high illuminance environment such as outdoors, display luminance may be at 100% level to make the display readable. This level of luminance may be too bright in lower illuminance environments such as indoors, and the display luminance can be decreased to an optimal viewing level. When inserting blank fields 11 within display frames 9, the display 6 has a much improved perceived moving image quality and the display 6 consumes less power.

The controller 2 is configured to control the effective brightness by changing the duration of the blank fields 11 inserted between the frames of data 5. As the detected illuminance 15 decreases the duration of the blank fields 11 increases producing lower display luminance and reducing power consumption. As the detected illuminance 15 increases the duration of the blank fields 11 decreases.

The controller 2 is configured to dynamically change the duration of the inserted blank fields 11. The change may be in real-time and dependent upon a dynamic change in the detected illuminance 15. However, typically changes do not happen instantaneously or rapidly, but have some time constant for a smooth and pleasant change. For convenience, in FIG. 2, changes appear instantly as this illustrates the control mechanism better.

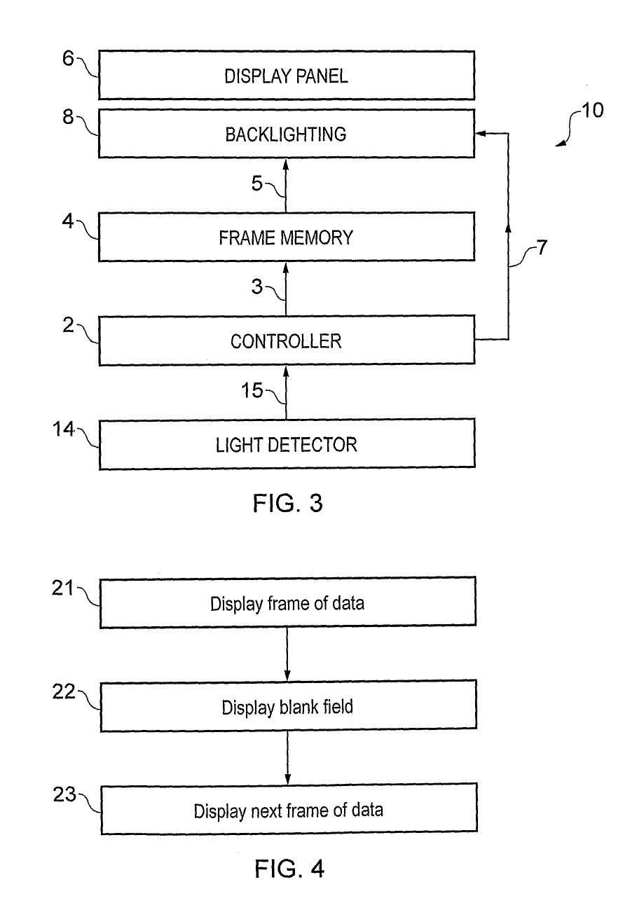

FIG. 3 schematically illustrates an example of how, in one example embodiment, the controller 2 may be configured to insert a blank field 11. The controller 2 uses a control signal 7 to control lighting for a display 6. In this illustrated example, the control signal 7 switches the lighting 8 on and off, but in other implementations it may dim the lighting instead of turning it off. Dimming would, however, typically involve a step-change in luminance. The blank field 11 is therefore a black or dark frame in which any data loaded into the display 6 is not visible.

In some cases the display frame can be formed from two successive images, one brighter another darker to make the overall image look correct without losses in screen luminance. The control of the lighting of the display may be achieved by controlling a backlight 8, if present, or, if a backlight is not present, by adapting the frame data 5. If a backlight is present, it may be an integral part of the display 6.

In this example, the control signal 7 switches the backlighting 8 on and off. The controller 2 is configured to control insertion of blank frames between frames of data 5 displayed on the display 6 by temporarily switching off the backlighting for the duration of the blank frame 11. A suitable control signal 7 is illustrated in FIG. 2. The example control signal 7 in FIG. 2, has a programmable duty cycle in which the backlighting 8 is off for Δ between time t1+mT and t1+Δ+mT and in which the backlighting 8 is on for T−Δ between time t1+Δ+mT and t1+T+mT, where m is an integer. In the illustrated example, t1 coincides with the beginning of a display frame 9 but t1 need not necessarily coincide with the beginning of a display frame 9.

The duty cycle may be constrained so that it can only have one or more values below 100% such as between 100% and 10%, where 100% represents no blank frame insertion.

The duty cycle can be controlled in dependence upon ambient light conditions. As the illuminance 15 decreases the duty decreases, inserting blank frames 11 of longer duration Δ.

The apparatus 10 may be an electronic apparatus or a module for an electronic apparatus. The apparatus 10 may, for example, be a hand portable apparatus or portable electronic device. It may, for example, be a mobile cellular telephone or a personal music, video or computing device or a digital camera.

Portable device may have associated constraints compared to larger device. These may include one or more of: power consumption, touch screen input, low cost requirements, wide environmental operating conditions including ambient illuminance (0 . . . >100 000 lux).

FIG. 4 schematically illustrates a method 20 for controlling a display 6.

At block 21, the display 6 displays a frame of data 5_{N} loaded into the display 6.

At block 22, the display 6 displays a blank field 11 in a manner dependent upon a detected context 15. For example, the display 6 may display a blank frame 11 for a duration dependent upon a detected context 15.

At block 23, the display 6 displays the next frame of data 5_{N+1}.

At block 22 or 23, the next frame of data 5 may be loaded into the display 6.

At block 22, the blank frame 11 may be displayed by temporarily switching off the backlighting for the duration of the blank frame. The backlighting may be switched on and off with a programmable duty cycle dependent upon the detected context 15, which may be ambient light illumination.

The controller 2 and/or frame memory 4 may be configured to enable the method 20.

Referring back to FIG. 2, the controller performs two purposes. It controls the insertion of blank fields 11 and it provides data to the frame memory. The controller will typically be part of a host apparatus and the frame memory and display 6 will typically be part of a display module 12.

However, the two purposes of the controller may be separated into separate controllers. A data controller would then provide the data and may be part of the host apparatus e.g. a processor and/or a graphics accelerator. A blank field controller would then control the blank field insertion and may be part of the display module 12. In this embodiment, the module comprises: a controller; a display; and a frame memory configured to load a frame of data to the display and configured to be filled by a frame of data from the controller. It may also comprise a detector. The controller is configured to control the insertion of blank fields with respect to frames of data displayed on the display in dependence upon a context detected by the detector.

Implementation of a controller 2 can be in hardware alone (a circuit, a processor . . . ), have certain aspects in software including firmware alone or can be a combination of hardware and software (including firmware).

The controller 2 may be implemented using instructions that enable hardware functionality, for example, by using executable computer program instructions in a general-purpose or special-purpose processor that may be stored on a computer readable storage medium (disk, memory etc) to be executed by such a processor.

The computer program may arrive at the apparatus via any suitable delivery mechanism. The delivery mechanism may be, for example, a computer-readable storage medium, a computer program product, a memory device, a record medium such as a CD-ROM or DVD, an article of manufacture that tangibly embodies the computer program. The delivery mechanism may be a signal configured to reliably transfer the computer program. The apparatus may propagate or transmit the computer program as a computer data signal.

Although the memory is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used here ‘module’ refers to a unit or apparatus that excludes certain parts/components that would be added by an end manufacturer or a user.

The blocks illustrated in the FIG. 4 may represent steps in a method and/or sections of code in the computer program. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus comprising:
a controller;
a display;
a frame memory configured to load a frame of data to the display and configured to be filled by a frame of data from the controller,
wherein the controller is configured to control the insertion of blank fields with respect to frames of data displayed on the display in dependence upon a detected context.

2. An apparatus as claimed in claim 1, wherein the controller is configured to start inserting blank fields with respect to frames of data displayed on the display in dependence upon detecting a predetermined change in context.

3. An apparatus as claimed in claim 2, wherein the predetermined change in context is a decrease in a detected illuminance below a threshold.

4. An apparatus as claimed in claim 1, wherein the controller is configured to change the duration of the inserted blank fields in dependence upon detecting a predetermined change in context.

5. An apparatus as claimed in claim 4, wherein the predetermined change in context is a change in detected illuminance.

6. An apparatus as claimed in claim 1, wherein the controller is configured to dynamically change the duration of the inserted blank fields in real-time dependence upon detecting a dynamic change in context.

7. An apparatus as claimed in claim 6, wherein the dynamic change in context is a change in detected illuminance.

8. An apparatus as claimed in claim 1, wherein the context is ambient light conditions.

9. An apparatus as claimed in claim 1, further comprising lighting for the display controlled by the controller; wherein the controller is configured to control insertion of blank fields with respect to frames of data displayed on the display by temporarily controlling the lighting for the duration of the blank field.

10. An apparatus as claimed in claim 9, wherein the controller is configured to switch the lighting with a programmable duty cycle.

11. An apparatus as claimed in claim 10, wherein the duty cycle is dynamically controllable to have a value between 100% and 10% .

12. An apparatus as claimed in claim 10, wherein the duty is dependent upon ambient light conditions.

13. An apparatus as claimed in claim 10, wherein the duty is dependent upon detected illuminance.

14. An apparatus as claimed in claim 1, further comprising a detector for detecting the context.

15. An apparatus as claimed in claim 14, wherein the detector is an ambient light sensor.

16. An apparatus as claimed in claim 1, wherein the display is a high luminance display.

17. Apparatus as claimed in claim 15, wherein the frame memory is configured to load frames of data to the display at a frame rate that is dependent upon ambient light conditions.

18. An apparatus as claimed in claim 1, wherein the controller is configured to control the insertion of blank fields between frames of data displayed on the display in dependence upon a detected context.

19. An apparatus as claimed in claim 18, further comprising backlighting for the display controlled by the controller; wherein the controller is configured to control insertion of blank fields between frames of data displayed on the display by temporarily switching off or dimming the backlighting for the duration of the blank field.

20. An apparatus as claimed in claim 1, wherein the controller is configured to control the scanning of blank sub-frames across the display in dependence upon a detected context.

21. An apparatus as claimed in claim 1, wherein the apparatus is a portable electronic device.

22. A module comprising:
a controller;
a display;
a frame memory configured to load a frame of data to the display and configured to be filled by a frame of data from the controller,
wherein the controller is configured to control the insertion of blank fields with respect to frames of data displayed on the display in dependence upon a context detected by a detector.

23. A module as claimed in claim 22, further comprising lighting for the display controlled by the controller; wherein the controller is configured to control insertion of blank fields with respect to frames of data displayed on the display by temporarily controlling the lighting for the duration of the blank field.

24. A module as claimed in claim 23, wherein the controller is configured to switch the lighting with a programmable duty cycle dependent upon the detected context.

25. A module as claimed in claim 22, wherein the detector is an ambient light sensor.

26. A method comprising:
causing a display to display a frame of data loaded from a frame memory;
causing the display to display a blank field for a duration dependent upon a detected context;
causing the frame memory to be filled from a controller by a second frame of data; and
causing the display to display the second frame of data.

27. A method as claimed in claim 26, further comprising temporarily controlling the lighting for the duration of the blank field to control insertion of blank fields with respect to frames of data displayed on the display.

28. A method as claimed in claim 27, wherein the lighting is switched with a programmable duty cycle dependent upon the detected context.

29. A method as claimed in claim 26, wherein the context is ambient light illumination.
